(19) United States
(12) Patent Application Publication
(10) Pub. No.: US 2018/0336751 A1
(43) Pub. Date: Nov. 22, 2018

(54) SYSTEMS AND METHODS FOR DELIVERING AUTONOMOUS RETAIL LOCKERS TO DOCKING STATIONS

(71) Applicant: Walmart Apollo, LLC, Bentonville, AR (US)

(72) Inventors: Bruce W. Wilkinson, Rogers, AR (US); Nathan G. Jones, Bentonville, AR (US); Todd D. Mattingly, Bentonville, AR (US)

(21) Appl. No.: 15/964,560

(22) Filed: Apr. 27, 2018

Related U.S. Application Data
(60) Provisional application No. 62/506,750, filed on May 16, 2017.

(51) Int. Cl. G07C 9/00; G06Q 50/28; G05D 1/02; G06Q 10/08

(52) U.S. Cl. CPC G07C 9/00896; G06Q 50/28; G05D 1/0297; G05D 2201/0213; G06Q 10/0836; G07C 2009/0092; G06Q 10/08355

(57) ABSTRACT

In some embodiments, apparatuses and methods are provided herein useful to deliver autonomous retail lockers to docking stations. In some embodiments, there is provided a system for delivering autonomous retail lockers to docking stations including an unmanned ground vehicle comprising a UGV control circuit; a first autonomous retail locker of a plurality of autonomous retail lockers each comprising: a product storage area; a transport system; a beacon receiver; and a retail locker control circuit configured to control the transport system to follow a homing signal and transport the first autonomous retail locker to couple with a docking station based on the homing signal received from the docking station, wherein the UGV control circuit is configured to identify when the UGV is at least within a threshold of a way point, and trigger a release of the first autonomous retail locker.

### CROSS-REFERENCE TO RELATED APPLICATION

This application claims the benefit of U.S. Provisional Application No. 62/506,750, filed May 16, 2017, which is incorporated herein by reference in its entirety.

### TECHNICAL FIELD

This invention relates generally to delivering autonomous retail lockers to docking stations.

### BACKGROUND

Generally, a delivery method by a retailer of a retail product that is associated with a retail order of a customer is through a delivery agent driving a delivery truck carrying a number of retail products associated with a number of retail orders from a number of customers. The delivery agent then drives to an address associated with the retail order. Consequently, the retail product is either given to a person at the address, left by a door or inside a mailbox of a house or a building associated with the address, or redelivered at another time to the address. At other times, a signature is required upon a delivery. Thus, the delivery agent will have to redeliver the retail product when there is not a person present or available to sign for the delivery at the address.

### BRIEF DESCRIPTION OF THE DRAWINGS

Disclosed herein are embodiments of systems, apparatuses and methods pertaining to delivering autonomous retail lockers to docking stations. This description includes drawings, wherein:

FIG. 1 illustrates a simplified block diagram of an exemplary system for delivering autonomous retail lockers to docking stations in accordance with some embodiments;

FIG. 2 is a simplified block diagram one or more elements of an exemplary system for delivering autonomous retail lockers to docking stations in accordance with some embodiments;

FIG. 3 shows a flow diagram of an exemplary process of delivering autonomous retail lockers to docking stations in accordance with some embodiments;

FIG. 4 shows a flow diagram of an exemplary process of delivering autonomous retail lockers to docking stations in accordance with some embodiments;

FIG. 5 shows a flow diagram of an exemplary process of delivering autonomous retail lockers to docking stations in accordance with some embodiments; and

FIG. 6 illustrates an exemplary system for use in implementing methods, techniques, devices, apparatuses, systems, servers, sources and delivering autonomous retail lockers to docking stations, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for delivering autonomous retail lockers to docking stations. In some embodiments, a system for delivering autonomous retail lockers to docking stations includes an unmanned ground vehicle (UGV). The UGV includes a UGV control circuit. By one approach, the system may include a first autonomous retail locker of a plurality of autonomous retail lockers. The plurality of autonomous retail lockers may be serially and releasably secured with the UGV in a train configuration. In one configuration, each of the plurality of autonomous retail lockers may include: a product storage area to store one or more retail products for delivery; and a transport system configured to transport the first autonomous retail locker across a distance. In another configuration, each of the plurality of autonomous retail lockers may include: a beacon receiver configured to detect a homing signal emitted by the docking station; and a retail locker control circuit communicatively coupled with the transport system and the beacon receiver.

By one approach, the retail locker control circuit may control the transport system to follow the homing signal and autonomously transport the first autonomous retail locker to couple with the docking station based on the homing signal received from the docking station. By another approach, the UGV may pull the plurality of autonomous retail lockers that are sequentially coupled in the train configuration along a delivery route. By another approach, the UGV control circuit may identify when the UGV is at least within a threshold of a way point corresponding to a drop-off location of the first autonomous retail locker. By such approach, the UGV control circuit may trigger a release of the first autonomous retail locker from the train configuration when the UGV is at least within the threshold of the way point.

In some embodiments, a method for delivering autonomous retail lockers to docking stations includes identifying when an UGV is at least within a threshold of a way point corresponding to a drop-off location of a first autonomous retail locker of a plurality of autonomous retail lockers. In one configuration, the plurality of autonomous retail lockers may be serially and releasably secured with the UGV in a train configuration. By one approach, the method may include triggering release of the first autonomous retail locker from the train configuration when the UGV is at least within the threshold of the way point. By another approach, subsequent to the release, the first autonomous retail locker couples with a docking station based on a homing signal received from the docking station.

By yet another approach, the method may include providing an in-range query signal to the docking station when the UGV is at least within the threshold of the way point. The method may also include receiving an in-range response signal from the docking station. By such approach, the method may include providing a release signal to the first autonomous retail locker in response to the receiving of the in-range response signal. In one configuration, the release signal may trigger the release of the first autonomous retail locker.

As such, apparatuses, systems, and/or methods described herein provide for autonomous delivery of autonomous retail lockers to docking stations that are efficient, seamless, and provide for less manual overhead labor to make deliveries of products to customers. In addition, a verification of delivery and/or redelivery of products due to incorrect delivery to a drop-off location is greatly reduced, if not eliminated, by the apparatuses, systems, and/or methods described herein. As used herein, the term autonomous retail locker refers to a retail locker having limited functional capability with minimal guidance from an unmanned vehicle, a control system or main control circuit separate from the retail locker, and/or the likes of devices that are capable of high throughput and/or complex processing capability. By one approach, an autonomous retail locker may not include a Ground Positioning Satellite (GPS) system. Instead, the autonomous retail locker may navigate towards a location based on a beacon signal (e.g., homing signal) transmitted and/or broadcasted, for example, by a docking station, a separate unmanned ground vehicles (UGV), or other systems. In one configuration, without a GPS system, the autonomous retail locker simply follows the direction from where the beacon signal is being transmitted and/or broadcasted, follows directional commands from a remote and separate system, implements a predefined route, back-tracks over a route previously taken (e.g., back-tracks part or all of a route previously taken while following a beacon signal), and/or other such motion control. By one approach, the autonomous retail locker may have a limited signal processing capability. As such, a control circuit associated with the autonomous retail locker may perform signal processing that is limited to determining a direction of a transmission source of the beacon signal, determining the beacon signal to follow, operating a transport system of the autonomous retail locker towards a location, receiving and executing basic communications and/or commands from an unmanned vehicle and/or the main control circuit, controlling a locking system of the retail locker, and/or maintaining temperature of retail products stored in a product storage area of the autonomous retail locker, among other types of functional capabilities operable on a locker control circuit having lesser throughput and simpler processing capability than the unmanned vehicle and the main control circuit, and/or the like. By one approach, the autonomous retail locker may be capable of maintaining the temperature of the retail products for a period of time sufficient to couple with a docking station. In one configuration, the autonomous retail locker may maintain the temperature of the retail products based on a product storage area including one or more insulated materials that have one or more grades of insulation. In another configuration, the autonomous retail locker may maintain the temperature of the retail products based on one or more passive cooling and/or heating approaches, for example, using a plurality of gel packs.

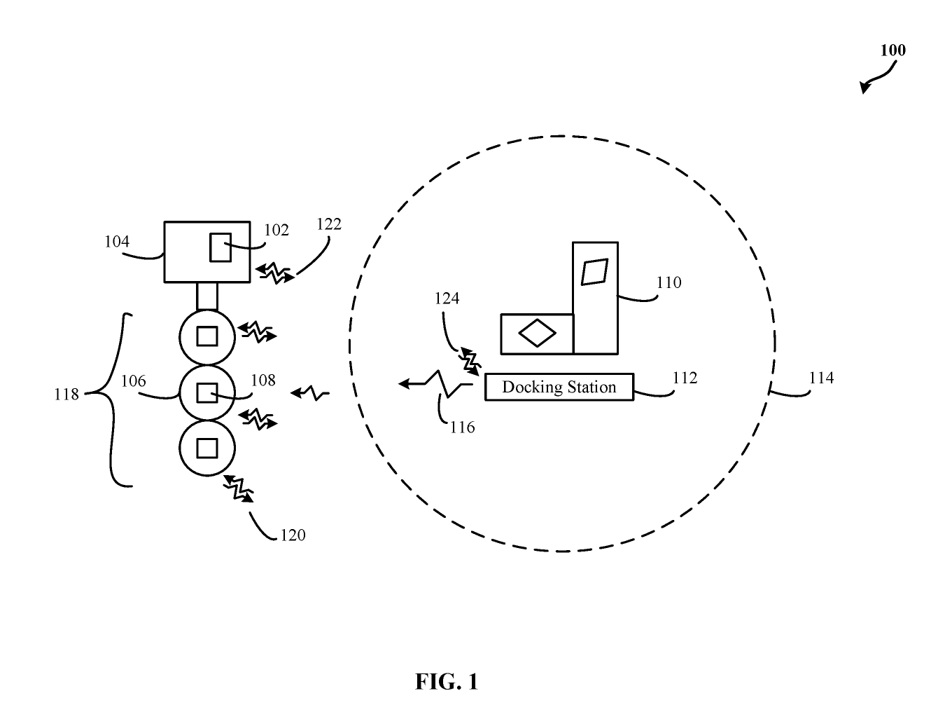

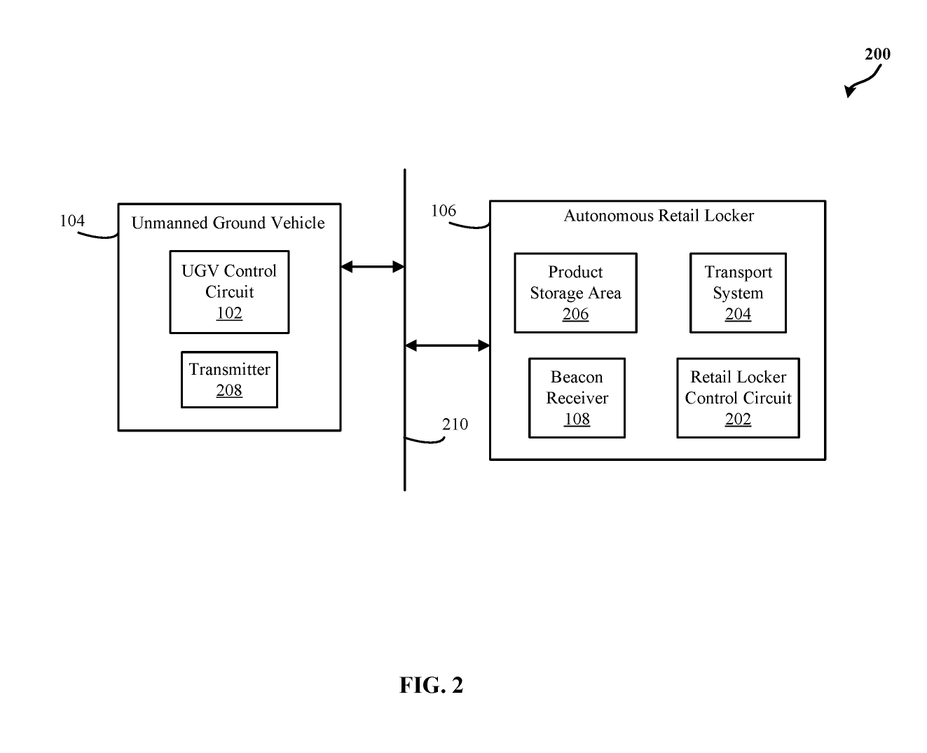

To illustrate, FIGS. 1 through 6 are described below. FIG. 1 and FIG. 2 are concurrently described herein. FIG. 1 illustrates a simplified block diagram of an exemplary system 100 that delivers autonomous retail lockers to docking stations, in accordance with some embodiments. FIG. 2 is a simplified block diagram one or more elements 200 of the exemplary system 100, in accordance with some embodiments. The system 100 includes a first autonomous retail locker 106 of a plurality of autonomous retail lockers 118. By one approach, each of the plurality of autonomous retail lockers 118 may include a beacon receiver 108. The beacon receiver 108 may comprise a receiver and/or a transceiver, among other devices that are capable of receiving radio and/or optical signals of one or more frequencies. In one configuration, the first autonomous retail locker 106 may include the beacon receiver 108. By one approach, the first autonomous retail locker 106 may include at least one of a product storage area 206, a transport system 204, and a retail locker control circuit 202. Typically, some or all of the plurality of retail lockers include at least one product storage area 206, at least one transport system 204, at least one transceiver, at least one beacon receiver 108, and at least one retail locker control circuit 202. The retail locker control circuit 202 may communicatively couple with the transport system 204 and the beacon receiver 108.

In another configuration, the system 100 includes one or more unmanned ground vehicles (UGV) 104. The UGV 104 includes a UGV control circuit 102. By one approach, the UGV 104 may also include a transmitter 208 that is communicatively coupled to the UGV control circuit 102. By another approach, the UGV 104 may be communicatively coupled to the first autonomous retail locker 106 via a network bus 210, and typically is communicatively coupled with each of the plurality of autonomous retail lockers 118. The network bus 210 is configured to pass communication signals through and/or between the UGV 104 and the first autonomous retail locker 106. By another approach, the plurality of autonomous retail lockers 118 may be serially and releasably secured with the UGV 104 in a train configuration. Accordingly, the UGV 104 further includes one or more locker couplers that physically secure at least one autonomous retail locker of the plurality of autonomous retail lockers 118 to an exterior of the UGV 104 to be pulled by the UGV 104 while the plurality of autonomous retail lockers 118 are supported by respective wheels, treads, tracks, or the like of the transport system 204. In some embodiments, each of the plurality of autonomous retail lockers 118 similarly include at least one and typically multiple physical couplers that are configured to physically couple with a locker coupler of the UGV 104 or with another physical coupler of another autonomous retail locker of the plurality of autonomous retail lockers 118. The locker coupler and/or physical couplers can be implemented through a janney coupler, magnetic coupler, retractable pin and aperture coupler, other such couplers or combination of two or more of such couplers.

By another approach, the plurality of autonomous retail lockers 118 may be releasably secured inside a storage space of the UGV 104. In such approach, apparatuses, methods, and/or systems described herein may alternatively, or in addition to, work and/or function similarly (including one or more elements as described in FIGS. 1-6) with the UGV 104 having the plurality of autonomous retail lockers 118 releasably secured inside the storage space of the UGV 104. In such an approach, the plurality of autonomous retail lockers 118 may not be sequentially coupled in a train configuration. By another approach, apparatuses, methods, and/or systems described herein may alternatively, or in addition to, work and/or function similarly (including one or more elements as described in FIGS. 1-6) with an unmanned aerial vehicle (UAV), alternatively or in addition to the UGV 104.

In some embodiment, the system 100 may include a docking station 112. The docking station 112 may be associated with a drop-off location 110. The drop-off location 110 may comprise an address and/or a physical structure or place of a house, a workplace, a facility, or a post office box associated with a customer and/or a retail order. By one approach, a way point 114 may correspond to the drop-off location 110. In one configuration, the docking station 112 may wirelessly send and/or receive communication/control signals 124 to and/or from at least one of the UGV 104 and the first autonomous retail locker 106 via a wireless network. The wireless network may comprise of Bluetooth, Long Term Evolution (LTE), 3G, 4G, 5G, and/or Wi-Fi, among other types of wireless protocols. Similarly, the UGV 104 may also wirelessly send and/or receive communication/control signals 122 to and/or from at least one of the autonomous retail locker 106 and the docking station 112 via the wireless network. In another configuration, the first autonomous retail locker 106 may wirelessly send and/or receive communication/control signals 120 to and/or from at least one of the UGV 104 and the docking station 112 via the wireless network.

In some embodiment, the first autonomous retail locker 106 may store one or more retail products for delivery in the product storage area 206. Further, the transport system 204 may transport the first autonomous retail locker 106 across a distance. Typically, the transport system 204 is configured to transport the first autonomous retail locker 106 a limited distance, while the UGV 104 is configured to transport the plurality of lockers much greater distances. As such, the retail locker control circuit 202 may transport the first autonomous retail locker 106 to a particular location by providing a control signal to the transport system 204. By one approach, the control signal may initiate transport of the first autonomous retail locker 106 towards the docking station 112. As such, the first autonomous retail locker 106 may follow a homing signal 116 emitted by the docking station 112. In one configuration, the homing signal 116 may provide locational data and/or directional data to the retail locker control circuit 202. Thus, the beacon receiver 108 may detect and/or receive the homing signal 116. The distance transported by the transport system 204 of the first autonomous retail locker 106 may be limited based on one or more of limited navigation capabilities, limited power and/or battery capacities, the transport system 204 may be a non-robust system with limited speed and/or limited obstacle avoidance capabilities, maneuverability, or the like. Alternatively, the UGV 104 typically includes a navigation system, a location detection system (e.g., GPS, wireless signal triangulation, image recognition, etc.), and a robust transport system that may move at greater speeds than the retail lockers. In some embodiments, the UGV 104 further comprises an obstacle avoidance system that detects obstacles (e.g., parked cars, curbs, potholes, etc.) and can autonomously take action in some instances (e.g., determines a route around the obstacle, determines an alternate route to a delivery destination, etc.) and/or communicates with a remote central system to receive alternate route data.

By one approach, the homing signal 116 may include a wireless data signal including an identifier associated with the docking station 112. In such an approach, prior to transmitting the homing signal 116, a docking control circuit (not shown) of the docking station 112 may perform signal processing to convert the identifier associated with the docking station 112 to the wireless data signal transmittable by a transmitter (not shown) of the docking station 112. In one configuration, the retail locker control circuit 202 may perform signal processing of the wireless data signal to extract the identifier associated with the docking station 112. In such configuration, the retail locker control circuit 202 may determine whether the identifier in the homing signal 116 corresponds to an identifier associated with the one or more retail products stored in the product storage area 206. As such, the identifier associated with the one or more retail products that are stored in the product storage area 206 may correspond to the docking station 112 with which the first autonomous retail locker 106 is assigned to couple. In response to the determination that the identifier in the homing signal 116 may correspond to the identifier associated with the one or more retail products, the retail locker control circuit 202 may lock-in to the homing signal 116 and control the transport system 204 to transport the first autonomous retail locker 106 towards a transmission source (e.g., the docking station 112) of the homing signal 116.

By another approach, the homing signal 116 may include a particular frequency associated with the transmitter of the docking station 112. The particular frequency may correspond to any frequency in an electromagnetic spectrum. In such approach, the retail locker control circuit 202 may perform signal processing of the particular frequency to determine a transmission source (e.g., the docking station 112) of the homing signal 116. For example, the particular frequency may comprise of a frequency in infrared spectrum. In another example, the beacon receiver 108 may comprise of a receiver capable of receiving infrared signal having a frequency in the infrared spectrum. In such example, the retail locker control circuit 202 may perform signal processing of a received infrared signal. In one configuration, the retail locker control circuit 202 may lock-in to the particular frequency of the homing signal 116 and, subsequently, lock-in a direction of the transmission source of the homing signal 116. As such, the retail locker control circuit 202 may control the transport system 204 to transport the first autonomous retail locker 106 towards the homing signal 116. Thus, in either approaches, the retail locker control circuit 202 may use the homing signal 116 to navigate towards the docking station 112. As such, the retail locker control circuit 202 may direct the transport system 204 by providing the control signal to the transport system 204. In one configuration, the control signal may include the locational data, the directional data, and/or a representational data of either a location or a direction towards the docking station 112. In another configuration, when the homing signal 116 is lost and/or unreceivable by the retail locker control circuit 202, the retail locker control circuit 202 may wait and stop transporting the first autonomous retail locker 106 towards the docking station 112 for a period of time until the retail locker control circuit 202 reacquires a signal lock of the homing signal 116. In another configuration, the retail locker control circuit 202 may transport the first autonomous retail locker 106 a threshold distance forward, backward, side to side, and/or rotate to acquire the signal lock. In yet another configuration, the first autonomous retail locker 106 may include a memory that stores one or more previously taken paths from the way point 114 to the docking station 112. The one or more previously taken paths may correspond to paths taken by the first autonomous retail locker 106 that resulted in coupling with the docking station 112. By one approach, the retail locker control circuit 202 may access the one or more previously taken paths via the memory when the first autonomous retail locker 106 loses the signal lock. In yet another configuration, the UGV 104 may provide one or more commands providing directional data to the retail locker control circuit 202 to transport the first autonomous retail locker 106 towards the docking station 112 when the retail locker control circuit 202 fails to reacquire the signal lock after at least a first attempt.

In another configuration, the first autonomous retail locker 106 may correspond to a limited-intelligence automated device having at least a particular purpose of transporting towards a coupling distance to the docking station 112 based on the homing signal 116. For example, the first autonomous retail locker 106 may not include a GPS system. Instead, the first autonomous retail locker 106 transport to the docking station 112, for example, simply based on the homing signal 116. In another example, the retail locker control circuit 202 may have a processing throughput that is at least a threshold slower than a processing throughput than the UGV 104 and/or a main control circuit (not shown). In yet another example, the retail locker control circuit 202 may have a processing throughput that is equal or at least a second threshold faster than the processing throughput than the UGV 104 and/or a main control circuit. In such a configuration, one or more functional capabilities of the retail locker control circuit 202 may be configured to be particularly limited to at least determining a direction of a transmission source of the homing signal 116, determining the homing signal 116 to follow, operating the transport system 204 towards a location, and/or receiving and executing basic commands from the UGV 104, docking station, and/or the main control circuit.

In another configuration, the UGV 104 may transmit a particular homing signal that the first autonomous retail locker 106 may be configured to receive and follow. For example, when the UGV 104 recalls the first autonomous retail locker 106 back, the UGV 104 may transmit the particular homing signal. By one approach, the retail locker control circuit 202 may receive the particular homing signal and transport the first autonomous retail locker 106 back to the UGV 104 using the transport system 204 based on the particular homing signal. In one configuration, the particular homing signal may comprise a signal identified by a plurality of autonomous retail lockers as associated with the UGV 104. In another configuration, the particular homing signal may be particularly identifiable by a particular autonomous retail locker as associated with the UGV 104.

In some embodiments, the first autonomous retail locker 106 may couple to the docking station 112 when the retail locker control circuit 202 determines that the first autonomous retail locker 106 is within a threshold coupling distance with the docking station 112. Thus, once the first autonomous retail locker 106 is coupled to the docking station 112, the delivery of the one or more retail products to a customer associated with a retail order may be complete. As such, the main control circuit that is communicatively coupled with the UGV 104 may provide a delivery complete message to a customer electronic device associated with a customer.

By one approach, the UGV 104 may move on to a subsequent docking station associated with the one or more products stored in the product storage area 206 when the UGV 104 receives a confirmation from the docking station 112 and/or autonomous retail locker that the first autonomous retail locker 106 is coupled to the docking station 112. By another approach, when, after a first period of time, the UGV 104 does not receive the confirmation, the UGV 104 may provide a notification to a customer and/or to the main control circuit indicating a coupling failure of the first autonomous retail locker 106 with the docking station 112. In one configuration, the main control circuit may provide a message to the customer indicating that the docking station 112 is unresponsive and request that the customer reboot the docking station 112. In another configuration, the UGV 104 and/or the main control circuit may provide an amplify-signal request to the docking station 112 to amplify the homing signal 116. Upon receiving the amplify-signal request, the docking station 112 may increase amplitude of the homing signal 116 to effectively enable the homing signal 116 to retain signal integrity at a greater distance. The main control circuit may provide a wait-for-a-period-of-time signal to the UGV 104. Subsequently, after a determination by the UGV 104 that after a predetermined wait time the UGV 104 still has not received the confirmation from the docking station 112 that the first autonomous retail locker 106 is coupled to the docking station 112 the UGV 104 may move on to the subsequent docking station.

In another configuration, the UGV 104 may, after a second period of time, return to the way point 114 after providing the notification to the main control circuit indicating the coupling failure of the first autonomous retail locker 106 with the docking station 112. In such configuration, the UGV 104 may provide a coupling-query signal to the docking station 112. The coupling-query signal corresponds to a request of a confirmation of a successful coupling between the docking station 112 to the first autonomous retail locker 106. In such configuration, when, after a third period of time, the UGV 104 fails to receive the confirmation, the UGV 104 may send a communication/control signal to the first autonomous retail locker 106 to return and/or couple to the UGV 104. As such, when the first autonomous retail locker 106 has returned and/or coupled to the UGV 104, the UGV 104 may secure the first autonomous retail locker 106 and move to a next docking station and/or to the distribution center.

By another approach, when, after the first period of time, the UGV 104 does not receive the confirmation from the docking station 112 that the first autonomous retail locker 106 is coupled to the docking station 112, the UGV 104 may send the communication/control signal to the first autonomous retail locker 106 to return and/or couple to the UGV 104. In such approach, upon securing the first autonomous retail locker 106, the UGV 104 may move to the next docking station and/or to the distribution center.

In some embodiments, the UGV 104 may pull the plurality of autonomous retail lockers 118 that are sequentially coupled in a train configuration along a delivery route. The delivery route may be provided to the UGV 104 by the main control circuit prior to the UGV 104 leaving a distribution center. The delivery route may include a plurality of way points associated with a plurality of delivery locations, drop-off locations of products stored in the product storage area 206, and/or a plurality of identifiers of a plurality of docking stations associated with the drop-off locations of the products stored in the product storage area 206. In one configuration, the main control circuit may track inventories of the distribution center, UGVs out for delivery, assign delivery routes to the UGVs, and/or modify a delivery route already provided to the UGV 104. In another configuration, the main control circuit is distinct and separate from the UGV control circuit 102 and/or the retail locker control circuit 202.

In some embodiments, the retail locker control circuit 202 may identify when the UGV 104 is at least within a threshold of the way point 114 corresponding to the drop-off location 110 of the first autonomous retail locker 106. In one configuration, the UGV 104 may include a Ground Positioning Satellite (GPS) system. The GPS system may provide locational data of the UGV 104 at any given time and/or periodically over a period of time to the UGV control circuit 102. By one approach, the UGV control circuit 102 may receive the locational data and compare the locational data with the way point 114 associated with one or more retail orders of the one or more products stored in the product storage area 206 of the first autonomous retail locker 106. When the UGV control circuit 102 determines, based on the comparison, that the UGV 104 is at least within the threshold of the way point 114, the UGV control circuit 102 may trigger a release of the first autonomous retail locker 106 from the train configuration. By one approach, the way point 114 may include a radial distance that is within a receiving range of the beacon receiver 108.

In another configuration, the release of the first autonomous retail locker 106 may be triggered by the UGV control circuit 102 receiving a homing-lock signal from the retail locker control circuit 202 in response to the retail locker control circuit 202 receiving and acquiring a signal lock of the homing signal 116. The beacon receiver 108 may receive the homing signal 116 as previously described above. By one approach, the UGV control circuit 102 may perform the signal lock of the homing signal 116 by executing multiple signal processing of the homing signal 116 to particularly determine the location and/or the direction of a transmission source of the homing signal 116. As such, the transport system 204 may transport the first autonomous retail locker 106 to the location and/or the direction of the docking station 112 that emits the homing signal 116.

In another configuration, the UGV control circuit 102 may transmit, via the transmitter 208, a release confirmation signal to the docking station 112 after the release of the first autonomous retail locker 106 from the train configuration. The docking station 112 may receive the release confirmation signal. By one approach, the release confirmation signal may, subsequently, trigger the docking station 112 to emit the homing signal 116. Thus, the homing signal 116 is not initially emitted by the docking station 112 until the receipt of the release confirmation signal by the docking station 112. As such, the release confirmation signal may communicate to the docking station 112 that the first autonomous retail locker 106 has been released by the UGV 104.

In yet another configuration, the UGV control circuit 102 may transmit, via the transmitter 208, a homing activation signal to the docking station 112 prior to a trigger releasing the first autonomous retail locker 106 from the train configuration. As such, upon the receipt of the homing activation signal from the UGV control circuit 102, the docking station 112 is triggered to initiate transmission of the homing signal 116. By one approach, subsequent to the transmission of the homing activation signal to the docking station 112, the UGV control circuit 102 may trigger the release of the first autonomous retail locker 106 from the train configuration. In some embodiments, the triggering of the release of the first autonomous retail locker 106 may be initiated in response to the first autonomous retail locker 106 confirming to the UGV 104 that it has acquired the homing signal 116.

In some embodiments, the UGV control circuit 102 may provide an in-range query signal to the docking station 112 when the UGV is at least within the threshold of the way point 114. By one approach, the in-range query signal may activate the docking station 112 from a sleeping state and signal to the docking station 112 to prepare for receiving and/or coupling with the first autonomous retail locker 106. Subsequently, the UGV control circuit 102 may receive an in-range response signal from the docking station 112. By one approach, the in-range response signal may communicate to the UGV control circuit 102 that the docking station 112 is prepared and/or about to be prepared to receive and/or couple with the first autonomous retail locker 106. In a preparation to receive and/or couple with first autonomous retail locker 106, the docking station 112 may execute a self-coupling test to test one or more components used by the docking station 112 to receive and/or couple with the first autonomous retail locker 106. For example, the docking station 112 may test a coupling mechanism to ensure a successful coupling with the first autonomous retail locker 106.

As such, the UGV control circuit 102 may provide a release signal to the first autonomous retail locker 106 in response to the receipt of the in-range response signal. Thus, the release signal triggers the release of the coupling of the first autonomous retail locker 106 with the UGV 104.

In some embodiments where each of the plurality of autonomous retail lockers 118 is magnetically daisy-chained to other one of the plurality of autonomous retail lockers 118 via one or more magnets, the release signal may cause application of voltage signal that induces the one or more magnets to decouple the first autonomous retail locker 106 from one or more autonomous retail lockers of the plurality of autonomous retail lockers 118. By one approach, each of the plurality of autonomous retail lockers 118 may be sequentially ordered in the train configuration based on the delivery route. In such an approach, the train configuration is a Last In First Out (LIFO) configuration. As such, in the LIFO configuration, a tail-end autonomous retail locker of the plurality of autonomous retail lockers 118 may be a first one to be released in the delivery route. By another approach, an un-dockable autonomous retail locker of the plurality of autonomous retail lockers 118 may be recoupled with the UGV 104. In one configuration, the UGV 104 may transmit a re-home signal to the first autonomous retail locker 106 in response to a failure of the first autonomous retail locker 106 to couple with the docking station 112. In such a configuration, the first autonomous retail locker 106 may follow the re-home signal transmitted by the UGV 104. The re-home signal may provide a directional data to the retail locker control circuit 202. Thus, the beacon receiver 108 may detect and/or receive the re-home signal. As such, the transport system 204 may transport the first autonomous retail locker 106 back to the UGV 104 based on the re-home signal. By one approach, an alignment sensor of the first autonomous retail locker 106 may cooperate with the beacon receiver 108 to realign and magnetically daisy-chain the first autonomous retail locker 106 with the UGV 104.

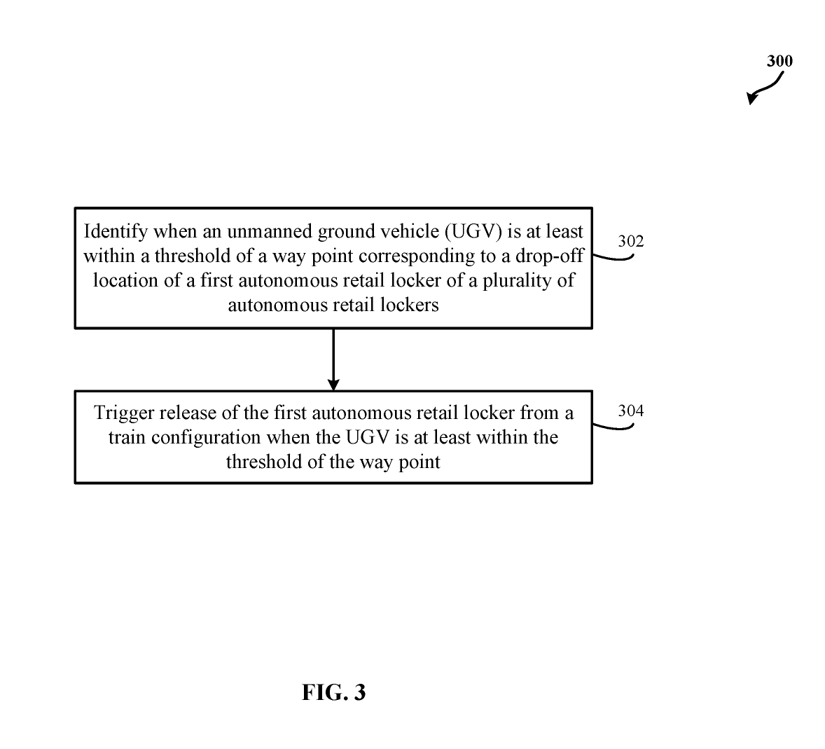

FIG. 3 illustrates a flow diagram of an exemplary process 300 of delivering autonomous retail lockers to docking stations, in accordance with some embodiments. The method 300 may be implemented in the system 100 of FIG. 1. By one approach, the method 300 may be implemented in at least one of the UGV 104, the plurality of autonomous retail lockers 118, and/or the first autonomous retail locker 106 of FIG. 1. By another approach, one or more steps in the method 300 may be implemented in at least one of the UGV 104, the plurality of autonomous retail lockers 118, and/or the first autonomous retail locker 106 of FIG. 1. The method 300 includes, at step 302, identifying when an unmanned ground vehicle (UGV) is at least within a threshold of a way point corresponding to a drop-off location of a first autonomous retail locker of a plurality of autonomous retail lockers. The plurality of autonomous retail lockers may be serially and releasably secured with the UGV in a train configuration. By one approach, the UGV may correspond to the UGV 104 of FIG. 1. By another approach, the plurality of autonomous retail lockers may correspond to the plurality of autonomous retail lockers 118 of FIG. 1. By another approach, the way point and the drop-off location may correspond to the way point 114 and the drop-off location 110 of FIG. 1. By another approach, the way point may include a radial distance that is within a receiving range of a beacon receiver of the first autonomous retail locker. In one configuration, the beacon receiver may correspond to the beacon receiver 108 of FIG. 1. In another configuration, the method 300 may include triggering release of the first autonomous retail locker from the train configuration when the UGV is at least within the threshold of the way point, at step 304. By one approach, subsequent to the release, the first autonomous retail locker may couple with a docking station based on a homing signal received from the docking station.

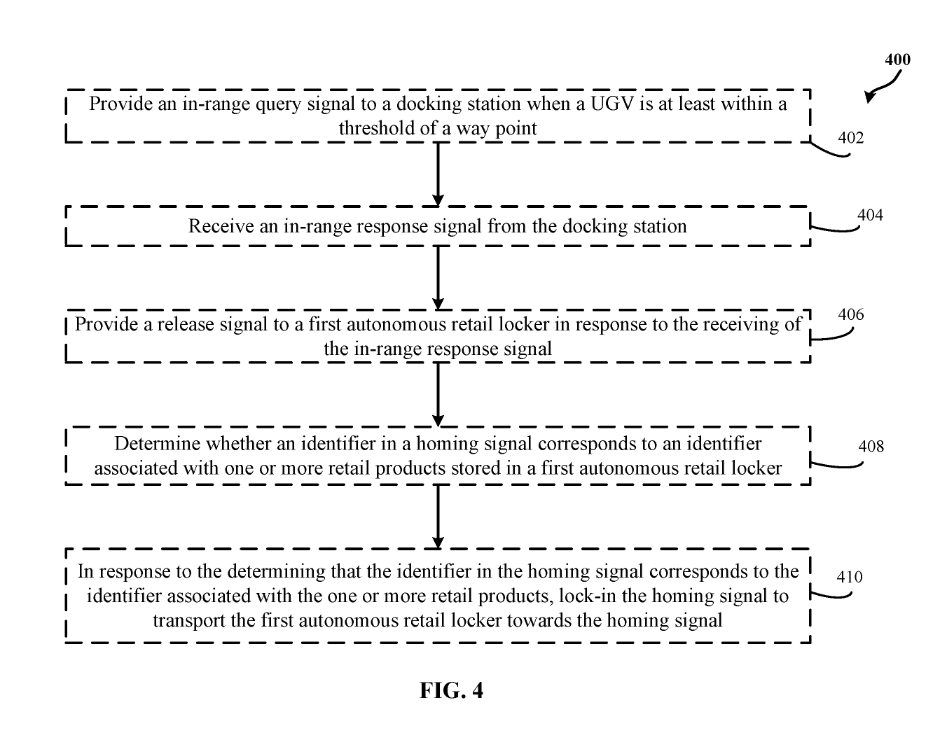

FIG. 4 illustrates a flow diagram of an exemplary process 400 of delivering autonomous retail lockers to docking stations, in accordance with some embodiments. The method 400 may be implemented in the system 100 of FIG. 1. By one approach, the method 400 may be implemented in at least one of the UGV 104, the plurality of autonomous retail lockers 118, and/or the first autonomous retail locker 106 of FIG. 1. By another approach, one or more steps in the method 400 may be implemented in at least one of the UGV 104, the plurality of autonomous retail lockers 118, and/or the first autonomous retail locker 106 of FIG. 1. By another approach, the method 400 and/or one or more steps of the method may optionally be included in and/or performed in cooperation with the method 300 of FIG. 3. The method 400 includes, at step 402, providing an in-range query signal to the docking station when the UGV is at least within the threshold of the way point. The docking station may correspond to the docking station 112 of FIG. 1. At step 404, the method 400 may include receiving an in-range response signal from the docking station. The method 400 may also include providing a release signal to the first autonomous retail locker in response to the receiving of the in-range response signal, at step 406. By one approach, the release signal may trigger the release of the first autonomous retail locker.

In some embodiments, the method 400 may include determining whether the identifier in the homing signal corresponds to an identifier associated with one or more retail products stored in the first autonomous retail locker, at step 408. By one approach, the method 400 may include, in response to the determining that the identifier in the homing signal corresponds to the identifier associated with the one or more retail products, locking-in the homing signal to transport the first autonomous retail locker towards the homing signal, at step 410.

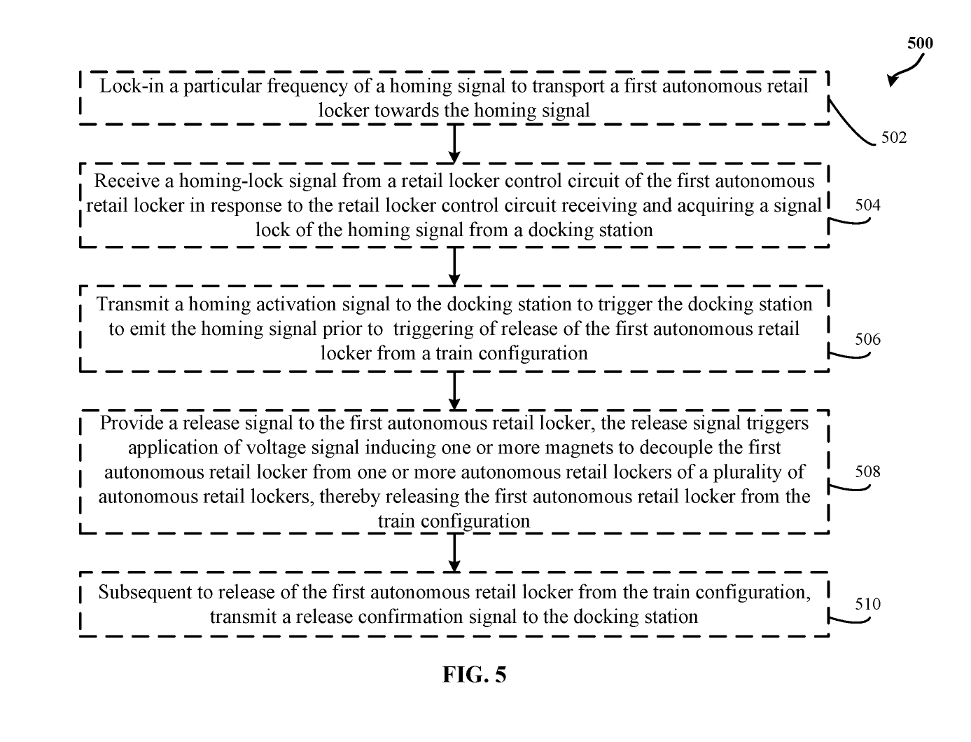

FIG. 5 illustrates a flow diagram of an exemplary process 500 of delivering autonomous retail lockers to docking stations, in accordance with some embodiments. The method 500 may be implemented in the system 100 of FIG. 1. By one approach, the method 500 may be implemented in at least one of the UGV 104, the plurality of autonomous retail lockers 118, and/or the first autonomous retail locker 106 of FIG. 1. By another approach, one or more steps in the method 500 may be implemented in at least one of the UGV 104, the plurality of autonomous retail lockers 118, and/or the first autonomous retail locker 106 of FIG. 1. By another approach, the method 500 and/or one or more steps of the method may optionally be included in and/or performed in cooperation with the method 300 of FIG. 3 and/or the method 400 of FIG. 4. The method 500 includes, at step 502, locking-in the particular frequency of the homing signal to transport the first autonomous retail locker towards the homing signal. By one approach, the first autonomous retail locker and the homing signal may correspond to the first autonomous retail locker 106 and the homing signal 116 of FIG. 1. The method 500 may include, at step 504, receiving a homing-lock signal from a retail locker control circuit of the first autonomous retail locker in response to the retail locker control circuit receiving and acquiring a signal lock of the homing signal from the docking station. By one approach, the release of the first autonomous retail locker is further triggered by the receiving of the homing-lock signal.

In another configuration, the method 500 may include transmitting a homing activation signal to the docking station to trigger the docking station to emit the homing signal prior to the triggering of release of the first autonomous retail locker from the train configuration, at step 506. In yet another configuration, the method 500, at step 508, may include providing a release signal to the first autonomous retail locker. By one approach, the release signal may trigger application of voltage signal that induces one or more magnets to decouple the first autonomous retail locker from one or more autonomous retail lockers of the plurality of autonomous retail lockers, thereby releasing the first autonomous retail locker from the train configuration. In yet another configuration, the method 500 may include, subsequent to the release of the first autonomous retail locker from the train configuration, transmitting a release confirmation signal to the docking station, wherein the release confirmation signal triggers the docking station to emit the homing signal, at step 510.

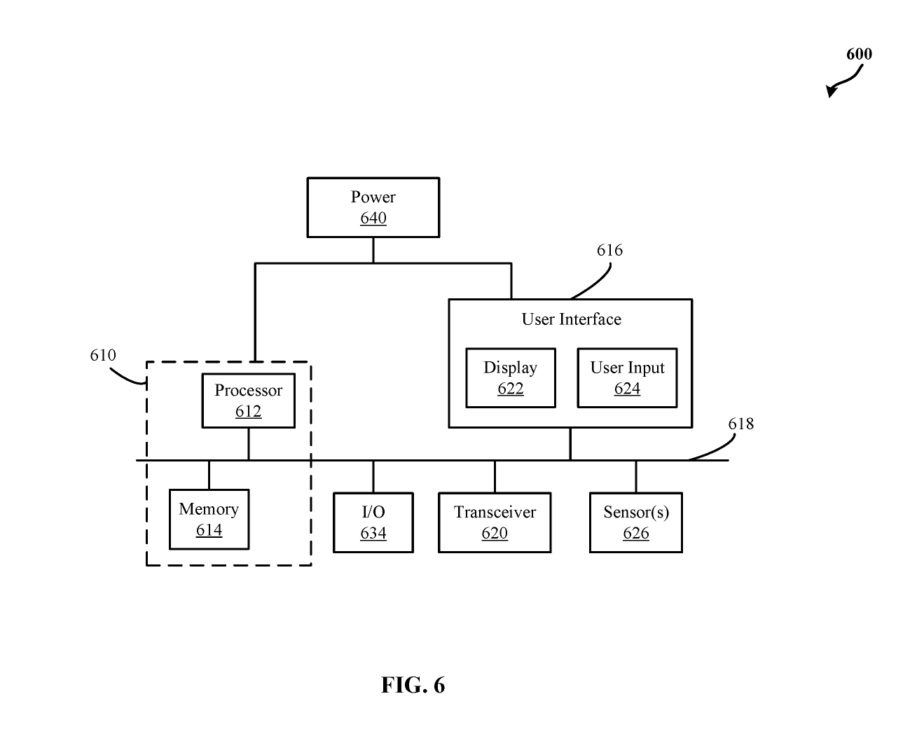

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the system 100 of FIG. 1, the method 300 of FIG. 3, the method 400 of FIG. 4, the method 500 of FIG. 5, and/or other above or below mentioned systems or devices, or parts of such circuits, circuitry, functionality, systems, apparatuses, processes, or devices. For example, the system 600 may be used to implement some or all of the system for delivering autonomous retail lockers 118 at docking stations 112, and/or other such components, circuitry, functionality and/or devices. However, the use of the system 600 or any portion thereof is certainly not required.

By way of example, the system 600 may comprise a processor module (or a control circuit) 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like. For example, the system 600 may implement the system for delivering autonomous retail lockers to docking stations 112 with the control circuit 102 being the control circuit 612.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) interface 634 that allow one or more devices to couple with the system 600. The I/O interface can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as a central control system, a UGV control circuit, a retail locker control circuit, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for delivering autonomous retail lockers to docking stations associated with a plurality of customers comprising:
an unmanned ground vehicle (UGV) comprising a UGV control circuit;
a first autonomous retail locker of a plurality of autonomous retail lockers, the plurality of autonomous retail lockers serially and releasably secured with the UGV in a train configuration, wherein each of the plurality of autonomous retail lockers comprises:
a product storage area to store one or more retail products for delivery;
a transport system configured to transport the first autonomous retail locker across a distance;
a beacon receiver configured to detect a homing signal emitted by a docking station; and
a retail locker control circuit communicatively coupled with the transport system and the beacon receiver, wherein the retail locker control circuit is configured to control the transport system to follow the homing signal and autonomously transport the first autonomous retail locker to couple with the docking station based on the homing signal received from the docking station; and
the UGV is configured to pull the plurality of autonomous retail lockers that are sequentially coupled in the train configuration along a delivery route, wherein the UGV control circuit is configured to:
identify when the UGV is at least within a threshold of a way point corresponding to a drop-off location of the first autonomous retail locker; and
trigger a release of the first autonomous retail locker from the train configuration when the UGV is at least within the threshold of the way point.

2. The system of claim 1, wherein the homing signal comprises a wireless data signal including an identifier associated with the docking station, and wherein the retail locker control circuit is further configured to:
determine whether the identifier in the homing signal corresponds to an identifier associated with the one or more retail products; and
in response to the determination that the identifier in the homing signal corresponds to the identifier associated with the one or more retail products, lock-in to the homing signal and control the transport system to transport the first autonomous retail locker towards the homing signal.

3. The system of claim 1, wherein the homing signal comprises a particular frequency associated with a transmitter of the docking station, and wherein the retail locker control circuit is further configured to lock-in to the particular frequency of the homing signal and control the transport system to transport the first autonomous retail locker towards the homing signal.

4. The system of claim 1, wherein the way point comprises a radial distance that is within a receiving range of the beacon receiver.

5. The system of claim 1, wherein the UGV further comprises a transmitter communicatively coupled with the UGV control circuit, wherein the UGV control circuit is further configured to transmit, via the transmitter, a release confirmation signal to the docking station after the release of the first autonomous retail locker from the train configuration, wherein the release confirmation signal triggers the docking station to emit the homing signal.

6. The system of claim 1, wherein the UGV further comprises a transmitter communicatively coupled with the UGV control circuit, wherein the UGV control circuit is further configured to transmit a homing activation signal to the docking station prior to the trigger releasing the first autonomous retail locker from the train configuration, and wherein the homing activation signal triggers the docking station to transmit the homing signal.

7. The system of claim 6, wherein the UGV control circuit is further configured to receive a homing-lock signal from the retail locker control circuit in response to the retail locker control circuit receiving and acquiring a signal lock of the homing signal, and wherein the release of the first autonomous retail locker is further triggered by the UGV control circuit receiving the homing-lock signal.

8. The system of claim 1, wherein the UGV control circuit is further configured to:
provide an in-range query signal to the docking station when the UGV is at least within the threshold of the way point;
receive an in-range response signal from the docking station; and
provide a release signal to the first autonomous retail locker in response to the receipt of the in-range response signal, wherein the release signal triggers the release of the first autonomous retail locker.

9. The system of claim 1, wherein each of the plurality of autonomous retail lockers is magnetically daisy-chained to other one of the plurality of autonomous retail lockers via one or more magnets, and wherein the release of the first autonomous retail locker is triggered by a release signal from the UGV control circuit, the release signal causes application of voltage signal that induces the one or more magnets to decouple the first autonomous retail locker from one or more autonomous retail lockers of the plurality of autonomous retail lockers.

10. A method for delivering autonomous retail lockers to docking stations associated with a plurality of customers comprising:
identifying when an unmanned ground vehicle (UGV) is at least within a threshold of a way point corresponding to a drop-off location of a first autonomous retail locker of a plurality of autonomous retail lockers, the plurality of autonomous retail lockers serially and releasably secured with the UGV in a train configuration; and
triggering release of the first autonomous retail locker from the train configuration when the UGV is at least within the threshold of the way point, wherein, subsequent to the release, the first autonomous retail locker couples with a docking station based on a homing signal received from the docking station.

11. The method of claim 10, wherein the homing signal comprises a wireless data signal including an identifier associated with the docking station, and further comprising:
determining whether the identifier in the homing signal corresponds to an identifier associated with one or more retail products stored in the first autonomous retail locker; and
in response to the determining that the identifier in the homing signal corresponds to the identifier associated with the one or more retail products, locking-in the homing signal to transport the first autonomous retail locker towards the homing signal.

12. The method of claim 10, wherein the homing signal comprises a particular frequency associated with a transmitter of the docking station, and further comprising locking-in the particular frequency of the homing signal to transport the first autonomous retail locker towards the homing signal.

13. The method of claim 10, wherein the way point comprises a radial distance that is within a receiving range of a beacon receiver of the first autonomous retail locker.

14. The method of claim 10, further comprising, subsequent to the release of the first autonomous retail locker from the train configuration, transmitting a release confirmation signal to the docking station, wherein the release confirmation signal triggers the docking station to emit the homing signal.

15. The method of claim 10, further comprising transmitting a homing activation signal to the docking station to trigger the docking station to emit the homing signal prior to the triggering of release of the first autonomous retail locker from the train configuration.

16. The method of claim 10, further comprising receiving a homing-lock signal from a retail locker control circuit of the first autonomous retail locker in response to the retail locker control circuit receiving and acquiring a signal lock of the homing signal from the docking station, wherein the release of the first autonomous retail locker is further triggered by the receiving of the homing-lock signal.

17. The method of claim 10, further comprising:
providing an in-range query signal to the docking station when the UGV is at least within the threshold of the way point;
receiving an in-range response signal from the docking station; and
providing a release signal to the first autonomous retail locker in response to the receiving of the in-range response signal, wherein the release signal triggers the release of the first autonomous retail locker.

18. The method of claim 10, further comprising providing a release signal to the first autonomous retail locker, the release signal triggers application of voltage signal inducing one or more magnets to decouple the first autonomous retail locker from one or more autonomous retail lockers of the plurality of autonomous retail lockers, thereby releasing the first autonomous retail locker from the train configuration.
